(19) United States
(12) Patent Application Publication
(10) Pub. No.: US 2021/0273357 A1
(43) Pub. Date: Sep. 2, 2021

(54) CONNECTOR ASSEMBLY WITH INTERCHANGEABLE FRONT

(71) Applicant: 3M INNOVATIVE PROPERTIES COMPANY, St. Paul, MN (US)

(72) Inventors: KokHoe Lee, Singapore (SG); Saujit Bandhu, Singapore (SG); Rao L. Vittapalli, SIngapore (SG); Chin Hua Lim, Singapore (SG); YunLong Qiao, Singapore (SG)

(21) Appl. No.: 17/252,414

(22) PCT Filed: Jun. 17, 2019
(86) PCT No.: PCT/IB2019/055055

§ 371 Date: Dec. 15, 2020

Related U.S. Application Data
(60) Provisional application No. 62/687,856, filed on Jun. 21, 2018.

(51) Int. Cl. H01R 12/70; H01R 12/72

(52) U.S. Cl. CPC H01R 12/7023; H01R 12/7082; H01R 12/727

(57) ABSTRACT

A connector that is configured to mate with different mating connectors by virtue of having different removably assembled interchangeable front housing portions includes a rear housing portion that includes a plurality of rear contacts. When the connector is to mate with a particular mating connector, a particular front housing portion of the connector that corresponds to the particular mating connector is selected from a plurality of available different front housing portions. The particular front housing portion is removably assembled to the rear housing portion, so that a plurality of front contacts of the particular front housing portion makes solderless physical and electrical contact with the plurality of rear contacts of the rear housing portion. The plurality of front contacts of the front housing portion are adapted to mate with corresponding contacts of the particular mating connector.

### TECHNICAL FIELD

The disclosure generally relates to connector assemblies having separable and interchangeable front portions.

### BACKGROUND

Cable assembly plug connectors of different interfaces such as miniSAS and PCIe, or receptacle connectors, require miniaturized, high speed interconnect systems. As interconnect systems progress toward miniaturization and higher signal speed, the system components are required to be, in parallel, designed to comply with these requirements. Interconnect assembly designs become more complex and intricate, and therefore require optimization to increase efficiency of the product design.

### SUMMARY

The various aspects and embodiments described herein relate to a connector and a connector assembly with reduced terminal array pitch, minimized components count, and exhibiting high signal speed without compromising the signal integrity quality.

An aspect of the present disclosure relates to a connector assembly including a circuit board. The circuit board includes an upper surface, an opposing lower surface, a front end and a cable end opposite the front end. A plurality of conductive front pads is disposed on the upper and lower surfaces at the front end. A plurality of conductive rear pads is disposed on the upper and lower surfaces at the cable end and are electrically connected to the front pads. The connector assembly further includes at least one cable having a plurality of conductors. The front ends of the conductors terminate at the rear pads. A unitary rear housing is overmolded around the circuit board. A back portion of the unitary rear housing tightly encloses the front ends of the conductors, the cable end of the circuit board, and the rear pads. The unitary rear housing defines an open front end and a chamber extending rearwardly from the open front end to the back portion of the unitary rear housing. The open front end is proximate the front end of the circuit board, the frond pads being exposed to the chamber. A unitary front housing has a thinner front portion extending forwardly from a thicker rear portion. The thicker rear portion is removably assembled to the open front end of the unitary rear housing. The thinner front portion defines an open front end and a central slot extending from the open front end to the thicker rear portion. The central slot includes opposing top and bottom surfaces. A plurality of contacts is disposed on the top and bottom surfaces of the central slot, each contact including a flexible contact member exposed to the central slot for making contact with a corresponding contact of a mating connector. A retaining member extends from the flexible contact member and is secured in the unitary front housing. A flexible termination member extends rearwardly from the contact member and makes solderless physical and electrical contact with a corresponding front pad of the circuit board.

Some embodiments are directed to a connector assembly configured to mate with different mating connectors by virtue of having different removably assembled interchangeable front housing portions. The connector assembly includes a circuit board having a plurality of conductive front pads disposed at a front end of the circuit board and a plurality of conductive rear pads disposed at an opposite cable end of the circuit board. The connector assembly also includes a cable terminated at the plurality of the rear pads. A rear housing portion houses the circuit board and portions of the cable. The front pads of the circuit board are disposed proximate an open front end of the rear housing portion, such that a front housing portion of the connector assembly is removably assembled to the open front end of the of the rear housing portion when the front housing portion moves toward the rear housing portion along a mating direction of the connector assembly until the front end of the circuit board deflects flexible contacts of the front housing portion away from the circuit board and a latch of one of the front and rear housing portions engages an engagement member of the other one of the front and rear housing portions.

A further aspect of the disclosure relates to a connector configured to mate with different mating connectors by virtue of having different removably assembled interchangeable front housing portions. The connector includes a rear housing portion having a plurality of rear contacts, such that when the connector is to mate with a particular mating connector, a particular front housing portion of the connector corresponding to the particular mating connector is selected from a plurality of available different front housing portions, and removably assembled to the rear housing portion, so that a plurality of front contacts of the particular front housing portion make solderless physical and electrical contact with the plurality of rear contacts of the rear housing portion. The plurality of front contacts of the front housing portion is adapted to mate with corresponding contacts of the particular mating connector.

These and other aspects of the present application will be apparent from the detailed description below. In no event, however, should the above summaries be construed as limitations on the claimed subject matter, which subject matter is defined solely by the attached claims.

### BRIEF DESCRIPTION OF DRAWINGS

The various aspects of the disclosure will be discussed in greater detail with reference to the accompanying figures where,

FIG. 1 schematically shows a connector assembly according to an embodiment;

FIG. 2 shows a partially exploded view of the connector assembly;

FIG. 3 schematically shows a rear housing portion overmolded around a circuit board;

FIGS. 4 and 5 schematically show a circuit board assembled with plurality of cable conductors;

FIG. 6 schematically shows a cross section of the connector assembly according to an embodiment in its fully mated position;

FIG. 7 schematically shows a cross section of the connector assembly with a mating connector;

FIG. 8 shows a cross section of the rear housing portion overmolded around a circuit board and portions of a cable;

FIGS. 9-11 schematically show contact members adapted to be housed in a front housing portion; and

FIG. 12 schematically shows a connector according to an aspect of the disclosure;

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION OF ILLUSTRATIVE EMBODIMENTS

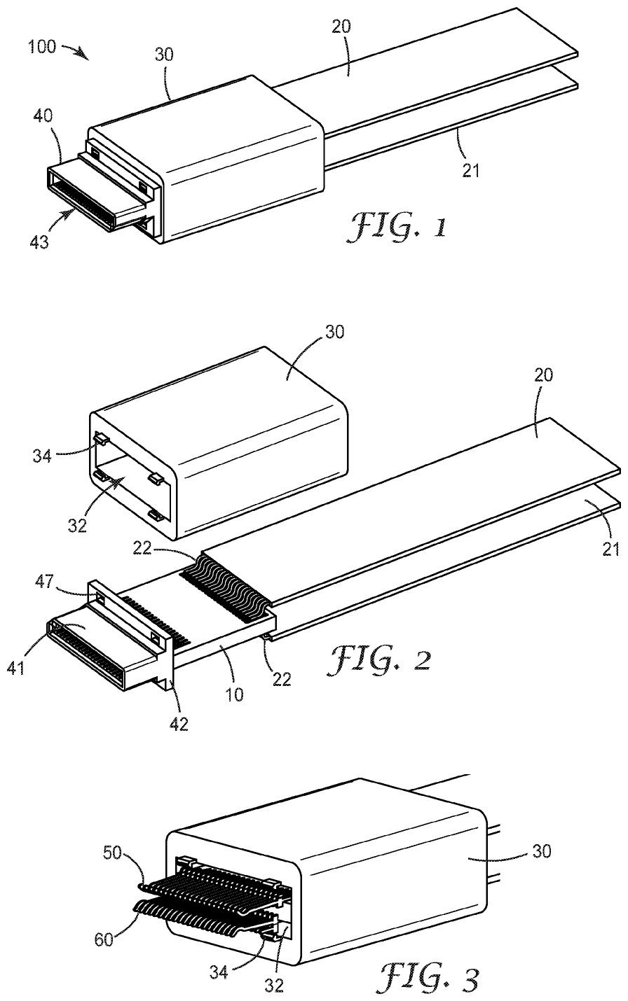

As illustrated in FIGS. 1-3, a connector assembly (100) includes a circuit board (10), at least one cable (20, 21) having a plurality of conductors (22), a rear housing portion (30) overmolded around the circuit board (10), and a front housing portion (40), which, in certain embodiments, is removably assembled to an open front end (32) of the rear housing portion (30). In certain embodiments, the rear and front housing portions (30, 40) are unitary in construction.

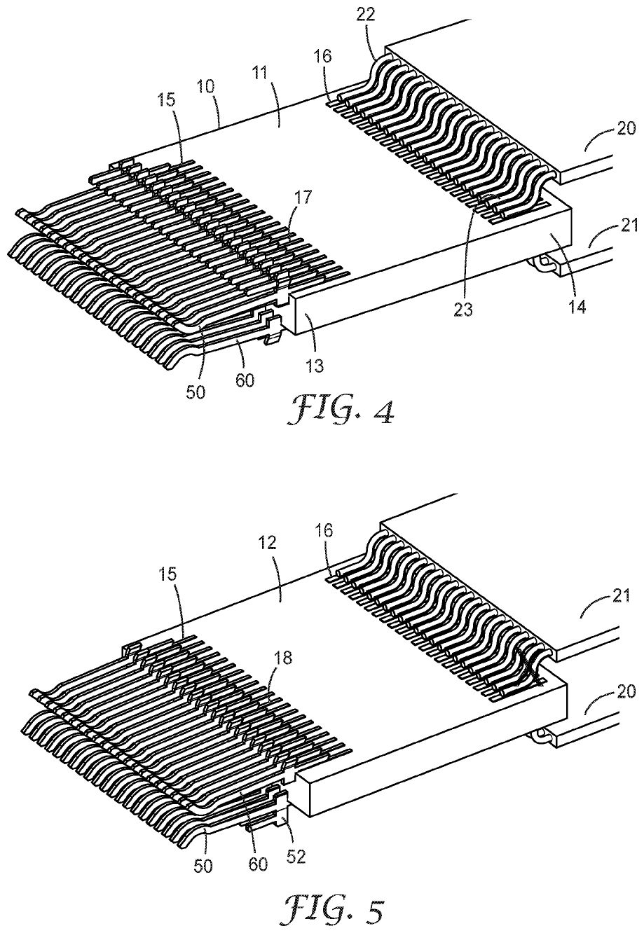

Referring now to FIGS. 4 and 5, the circuit board (10) includes an upper surface (11), an opposing lower surface (12), a front end (13), and a cable end (14) opposite the front end. The circuit board (10) includes a plurality of conductive front pads (15) disposed at the front end (13) of the circuit board and a plurality of conductive rear pads (16) disposed at the opposite cable end (14) of the circuit board. In some cases, the plurality of conductive front pads (15) are disposed on the upper and lower surfaces (11, 12) at the front end (13) and a plurality of conductive rear pads (16) are disposed on the upper and lower surfaces (11, 12) at the cable end (14) and are electrically connected to the front pads (15). The cables (20, 21) terminate at the plurality of rear pads (16). In one aspect, front ends (23) of the conductors (22) of the cable (20, 21) terminate at the rear pads (16). In certain aspects, the at least one cable (20, 21) includes an upper cable (20) terminated at the rear pads (16) of the circuit board (10) disposed on the upper surface (11) of the circuit board (10), and a lower cable (21) terminated at the rear pads (16) of the circuit board (10) disposed on the lower surface (12) of the circuit board (10).

In some cases, the circuit board (10) is fully enclosed within the unitary rear housing (30). In comes cases, the rear housing portion (30) may house the circuit board (10) and portions of the cable (20, 21). In some cases, the rear housing portion (30) is overmolded around the circuit board (10) and tightly encloses the rear pads (16). In certain aspects, at least one of the unitary rear and front housings (30, 40) is overmolded around the circuit board (10) by one or more of injection molding, compression molding, blow molding, extrusion and casting.

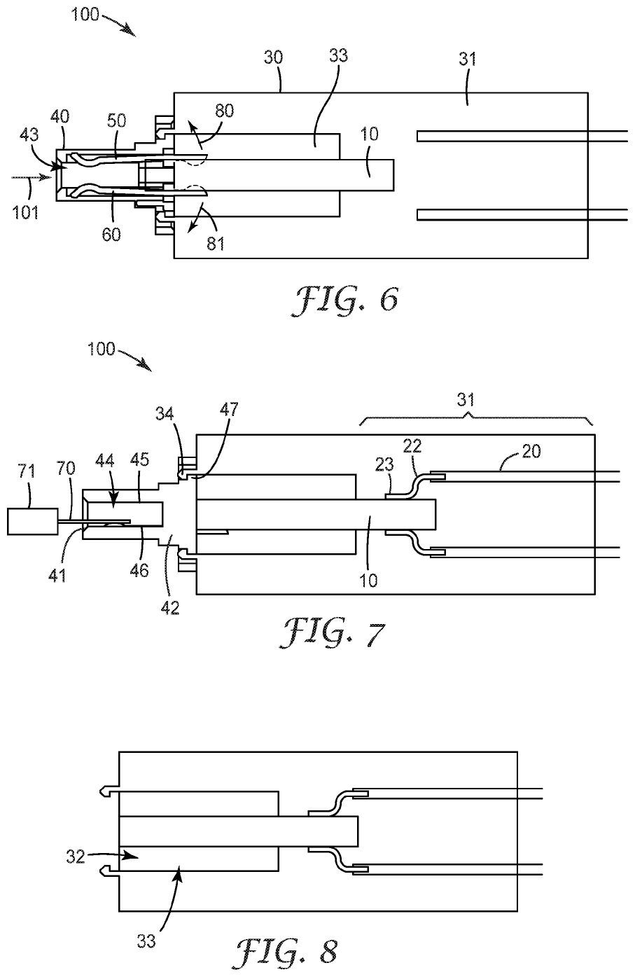

In the embodiment as shown in FIGS. 6 and 7, a back portion (31) of the unitary rear housing (30) tightly encloses the front ends (23) of the conductors (22), the cable end (14) of the circuit board (10) and the rear pads (16). As shown in FIGS. 2 and 8, the unitary rear housing (30) defines an open front end (32). A chamber (33) extends rearwardly from the open front end (32) to the back portion (31) of the unitary rear housing (30). The front pads (15) of the circuit board (10) are disposed proximate the open front end (32) of the rear housing portion (30). The open front end (32) is proximate the front end (13) of the circuit board (10) and the front pads (15) are exposed to the chamber (33).

The unitary rear housing (30) may be made of a plastic material. However, in certain other embodiments, the unitary rear housing may be made of a metal.

The connector assembly includes a unitary front housing (40) as illustrated best in FIGS. 1 and 2. The unitary front housing (40) has a thinner front portion (41) extending forwardly from a thicker rear portion (42). The unitary front housing (40) is removably assembled to the open front end (32) of the unitary rear housing (30). In a particular aspect, the thicker rear portion (42) of the unitary front housing (40) is removably assembled to the open front end (32) of the unitary rear housing (30). In one aspect, the open front end (32) of the unitary rear housing (30) may have a latch (34) and the thicker rear portion (42) of the unitary front housing (40) may include an engagement member (47) such that the thicker rear portion (42) is removably assembled to the open front end (32) of the unitary rear housing (30) by virtue of the latch (34) engaging the engagement member (47). In another aspect that is not illustrated, the open front end (32) of the unitary rear housing (30) may include an engagement member and the thicker rear portion (42) of the unitary front housing (40) may have a latch such that the thicker rear portion (42) is removably assembled to the open front end (32) of the unitary rear housing (30) by virtue of the latch engaging the engagement member.

As illustrated in FIGS. 6 and 7, the thinner front portion (41) defines an open front end (43) and a central slot (44) extending from the open front end (43) to the thicker rear portion (42). The central slot (44) includes opposing top (45) and bottom (46) surfaces. A plurality of contacts (50, 60) are disposed on the top and bottom surfaces (45, 46) of the central slot (44). In certain aspects, the plurality of contacts (50, 60) include a plurality of upper contacts (50) disposed on the top surface (45) of the central slot (44), and a plurality of lower contacts (60) disposed on the bottom surface (46) of the central slot (44). When the unitary front housing (40) is removably assembled to the open front end (32) of the unitary rear housing (30), the front end (13) of the circuit board (10) deflects the pluralities of upper and lower contacts (50, 60) away from each other.

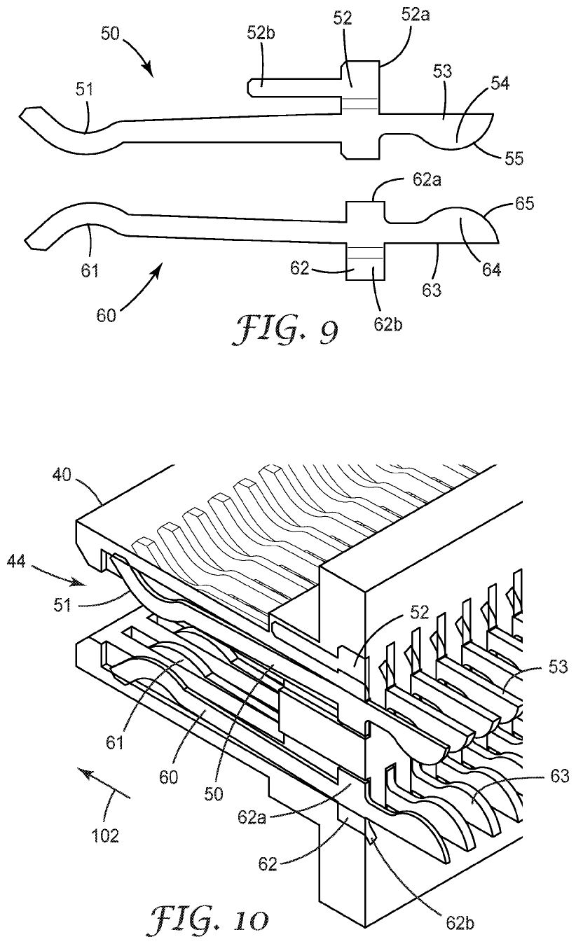

In certain aspects as illustrated in FIGS. 9 and 10, each of the pluralities of contacts (50, 60) may have a flexible contact member (51, 61), a retaining member (52, 62), and a flexible termination member (53, 63). The flexible contact member (51, 61) is exposed to the central slot (44) for making contact with a corresponding contact (70) of a mating connector (71) (as best seen in FIGS. 6 and 7). The retaining member (52, 62) extends from the flexible contact member (51, 61) and is secured in the unitary front housing (40). For example, the flexible contact member (51, 61) may be secured in the unitary front housing (40) at the thicker rear portion (42) of the unitary front housing (40). The flexible termination member (53, 63) extends rearwardly from the contact member (51, 61) and makes solderless physical and electrical contact with a corresponding front pad (15) of the circuit board (10) as best seen in FIGS. 4 and 5. In certain aspects, the flexible termination member (53, 63) sticks out from the retaining member (52, 62) to make solderless physical and electrical contact with a corresponding front pad (15) of the circuit board (10). The contacts (50, 60) may be pushed into the front housing (40) in a direction (102) as shown in FIG. 10.

Upon assembly of the unitary front housing (40) to the open front end (32) of the unitary rear housing (30), the flexible termination member (53, 63) is deflected by the front pad (15) corresponding to the flexible termination member (53, 63). In one aspect, the flexible termination member (53, 63) is deflected or flexed by the front pad (15) corresponding to the flexible termination member in a direction (80, 81) away from the front pad (15). In certain aspects as illustrated in FIG. 9, the flexible termination member (53, 63) has a disc portion (54, 64) having a peripheral edge (55, 65). The peripheral edge (55, 65) makes the solderless physical and electrical contact with the corresponding front pad (15) of the circuit board (10). In some cases, the peripheral edge (55, 65) has a curved profile as shown in FIG. 9.

In certain aspects, the unitary front housing (40) may be removably assembled to the open front end (32) of the of the unitary rear housing (30) by moving the unitary front housing (40) toward the unitary rear housing (30) along a mating direction (101) of the connector assembly (100) as best shown in FIG. 6. The front housing (40) may be moved along the mating direction (101) until the front end (13) of the circuit board (10) deflects the flexible contacts (50, 60) of the front housing portion (40) in a direction (80, 81) away from the circuit board (10) and a latch (34) of one of the front and rear housings (40, 30) engages an engagement member (47) of the other one of the front and rear housings (40, 30). In certain aspects, the front end (13) of the circuit board (10) deflects the flexible termination members (53, 63) of the contacts (50, 60) in a direction (80, 81) away from the circuit board (10) when the front housing (40) is moved along the mating direction (101).

The connector assembly (100) may be configured to mate with different mating connectors (71) by virtue of having different removably assembled interchangeable front housing portions (40).

In another embodiment as best shown in FIG. 12, a connector (200) is configured to mate with different mating connectors (71) by virtue of having different removably assembled interchangeable front housing portions (40). The connector (200) includes a rear housing portion (30) having a plurality of rear contacts (15). When the connector (200) is to mate with a particular mating connector (71), a particular front housing portion (40) of the connector corresponding to the particular mating connector is selected from a plurality of available different front housing portions. The particular front housing portion (40) may be removably assembled to the rear housing portion (30), so that a plurality of front contacts (50, 60) of the particular front housing portion (40) make solderless physical and electrical contact with the plurality of rear contacts (15) of the rear housing portion (30). The plurality of front contacts (50, 60) of the front housing portion (40) may be adapted to mate with corresponding contacts (70) of the particular mating connector (71). In some cases, rear contacts (15) may be contact pads on a circuit board (10).

In some aspects, the plurality of rear contacts (15) includes a plurality of upper rear contacts (17) and a plurality of lower rear contacts (18) as shown in FIGS. 4 and 5. The plurality of front contacts (50, 60) includes a plurality of upper front contacts (50) and a plurality of lower front contacts (60). When the particular front housing portion (40) is removably assembled to the rear housing portion (30), the upper front contacts (50) deflect upwardly and make solderless physical and electrical contact with the upper rear contacts (17), and the lower front contacts (60) deflect and make solderless physical and electrical contact with the lower rear contacts (18). The deflection of the upper and lower front contacts (50, 60) generates deflection force ensuring electrical connection between the front (50, 60) and rear (17, 18) contacts.

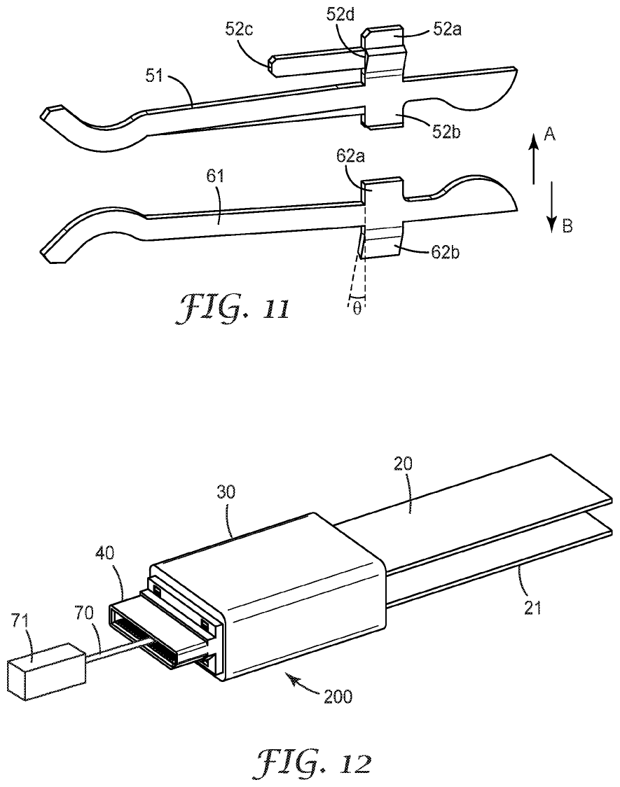

In some embodiments, as best shown in FIGS. 9 and 11, the retaining member (52, 62) of each of the upper and lower front contacts (50, 60) may include a first arm (52a, 62a) extending from the flexible contact member (51, 61) along a first direction (A) and a second arm (52b, 62b) extending from the flexible contact member (51, 61) along an opposite second direction (B) so that the first and second arms are on opposite sides of the flexible contact member. Furthermore, in some embodiments, the retaining member of at least one of the of the upper and lower front contacts, such as the retaining member (52) of the upper front contact, may further include a third arm (52c) extending from a midpoint (52d) of the first arm in a direction substantially parallel to the flexible contact member (51). Furthermore, in some embodiments, the first and second arms of the retaining member of at least one of the of the upper and lower front contacts, such as the first (62a) and second (62b) arms of the retaining member (62) of the lower front contact, may make an oblique angle (θ) with one another. The first, second and third arms facilitate retention of the contacts (50) within the front housing portion (40).

Embodiments disclosed herein include:

Embodiment 1. A connector assembly including: a circuit board including: an upper surface and an opposing lower surface; a front end and a cable end opposite the front end; a plurality of conductive front pads disposed on the upper and lower surfaces at the front end; and a plurality of conductive rear pads disposed on the upper and lower surfaces at the cable end and electrically connected to the front pads; at least one cable including a plurality of conductors, front ends of the conductors terminated at the rear pads; a unitary rear housing overmolded around the circuit board, a back portion of the unitary rear housing tightly enclosing the front ends of the conductors, the cable end of the circuit board and the rear pads, the unitary rear housing defining an open front end and a chamber extending rearwardly from the open front end to the back portion of the unitary rear housing, the open front end proximate the front end of the circuit board, the frond pads exposed to the chamber; and a unitary front housing including a thinner front portion extending forwardly from a thicker rear portion, the thicker rear portion removably assembled to the open front end of the unitary rear housing, the thinner front portion defining an open front end and a central slot extending from the open front end to the thicker rear portion, the central slot including opposing top and bottom surfaces; a plurality of contacts disposed on the top and bottom surfaces of the central slot, each contact including: a flexible contact member exposed to the central slot for making contact with a corresponding contact of a mating connector; a retaining member extending from the flexible contact member and secured in the unitary front housing; and a flexible termination member extending rearwardly from the contact member and making solderless physical and electrical contact with a corresponding front pad of the circuit board.

Embodiment 2. The connector assembly of Embodiment 1, wherein the circuit board is fully enclosed within the unitary rear housing.

Embodiment 3. The connector assembly of Embodiment 1, wherein the open front end of the unitary rear housing includes a latch and the thicker rear portion of the unitary front housing includes an engagement member, and wherein the thicker rear portion is removably assembled to the open front end of the unitary rear housing by virtue of the latch engaging the engagement member.

Embodiment 4. The connector assembly of Embodiment 1, wherein the flexible termination member is deflected by the front pad corresponding to the flexible termination member.

Embodiment 5. The connector assembly of Embodiment 1, wherein the flexible termination member includes a disc portion including a peripheral edge making solderless physical and electrical contact with the corresponding front pad of the circuit board.

Embodiment 6. The connector assembly of claim 1, wherein the flexible termination member is flexed by the front pad of the circuit board corresponding to the flexible termination member in a direction away from the front pad.

Embodiment 7. The connector assembly of claim 1, wherein the at least one cable includes an upper cable terminated at the rear pads of the circuit board disposed on the upper surface of the circuit board, and a lower cable terminated at the rear pads of the circuit board disposed on the lower surface of the circuit board.

Embodiment 8. The connector assembly of claim 1, wherein the unitary rear housing is made of a plastic.

Embodiment 9. The connector assembly of claim 1, wherein the unitary rear housing is made of a metal.

Embodiment 10. The connector assembly of claim 1, wherein at least one of the unitary rear and front housings is overmolded around the circuit board by one or more of injection molding, compression molding, blow molding, extrusion and casting.

Embodiment 11. The connector assembly of claim 1, wherein the unitary front housing is removably assembled to the open front end of the of the unitary rear housing by the unitary front housing moving toward the unitary rear housing along a mating direction of the connector assembly until the front end of the circuit board deflects the flexible termination members of the contacts away from the circuit board and a latch of one of the front and rear housings engages an engagement member of the other one of the front and rear housings.

Embodiment 12. The connector assembly of Embodiment 1, wherein the plurality of contacts includes a plurality of upper contacts disposed on the top surface of the central slot, and a plurality of lower contacts disposed on the bottom surface of the central slot, such that when the unitary front housing is removably assembled to the open front end of the unitary rear housing, the front end of the circuit board deflects the pluralities of upper and lower contacts away from each other.

Embodiment 13. A connector assembly configured to mate with different mating connectors by virtue of having different removably assembled interchangeable front housing portions, the connector assembly including: a circuit board including a plurality of conductive front pads disposed at a front end of the circuit board and a plurality of conductive rear pads disposed at an opposite cable end of the circuit board; a cable terminated at the plurality of the rear pads; and a rear housing portion housing the circuit board and portions of the cable, the front pads of the circuit board disposed proximate an open front end of the rear housing portion, such that a front housing portion of the connector assembly is removably assembled to the open front end of the of the rear housing portion when the front housing portion moves toward the rear housing portion along a mating direction of the connector assembly until the front end of the circuit board deflects flexible contacts of the front housing portion away from the circuit board and a latch of one of the front and rear housing portions engages an engagement member of the other one of the front and rear housing portions.

Embodiment 14. The connector assembly of Embodiment 13, wherein the rear housing portion is overmolded around the circuit board and tightly encloses the rear pads.

Embodiment 15. The connector assembly of Embodiment 13, wherein the rear housing portion is a unitary construction.

Embodiment 16. The connector assembly of Embodiment 13, wherein the rear housing portion is made of a plastic.

Embodiment 17. The connector assembly of Embodiment 13, wherein the rear housing portion is made of a metal.

Embodiment 18. A connector configured to mate with different mating connectors by virtue of having different removably assembled interchangeable front housing portions, the connector including: a rear housing portion including a plurality of rear contacts, such that when the connector is to mate with a particular mating connector, a particular front housing portion of the connector corresponding to the particular mating connector is selected from a plurality of available different front housing portions, and removably assembled to the rear housing portion, so that a plurality of front contacts of the particular front housing portion make solderless physical and electrical contact with the plurality of rear contacts of the rear housing portion, the plurality of front contacts of the front housing portion adapted to mate with corresponding contacts of the particular mating connector.

Embodiment 19. The connector of Embodiment 18, wherein the plurality of rear contacts includes a plurality of upper rear contacts and a plurality of lower rear contacts, and wherein the plurality of front contacts includes a plurality of upper front contacts and a plurality of lower front contacts, such that when the particular front housing portion is removably assembled to the rear housing portion, the upper front contacts deflect upwardly and make solderless physical and electrical contact with the upper rear contacts, and the lower front contacts deflect and make solderless physical and electrical contact with the lower rear contacts, the deflection of the upper and lower front contacts generating deflection force ensuring electrical connection between the front and rear contacts.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A connector assembly comprising:
a circuit board comprising:
an upper surface and an opposing lower surface;
a front end and a cable end opposite the front end;
a plurality of conductive front pads disposed on the upper and lower surfaces at the front end; and
a plurality of conductive rear pads disposed on the upper and lower surfaces at the cable end and electrically connected to the front pads;
at least one cable comprising a plurality of conductors, front ends of the conductors terminated at the rear pads;
a unitary rear housing overmolded around the circuit board, a back portion of the unitary rear housing tightly enclosing the front ends of the conductors, the cable end of the circuit board and the rear pads, the unitary rear housing defining an open front end and a chamber extending rearwardly from the open front end to the back portion of the unitary rear housing, the open front end proximate the front end of the circuit board, the frond pads exposed to the chamber; and
a unitary front housing comprising a thinner front portion extending forwardly from a thicker rear portion, the thicker rear portion removably assembled to the open front end of the unitary rear housing, the thinner front portion defining an open front end and a central slot extending from the open front end to the thicker rear portion, the central slot comprising opposing top and bottom surfaces;
a plurality of contacts disposed on the top and bottom surfaces of the central slot, each contact comprising:
a flexible contact member exposed to the central slot for making contact with a corresponding contact of a mating connector;
a retaining member extending from the flexible contact member and secured in the unitary front housing; and
a flexible termination member extending rearwardly from the contact member and making solderless physical and electrical contact with a corresponding front pad of the circuit board.

2. The connector assembly of claim 1, wherein the circuit board is fully enclosed within the unitary rear housing.

3. The connector assembly of claim 1, wherein the open front end of the unitary rear housing comprises a latch and the thicker rear portion of the unitary front housing comprises an engagement member, and wherein the thicker rear portion is removably assembled to the open front end of the unitary rear housing by virtue of the latch engaging the engagement member.

4. The connector assembly of claim 1, wherein the flexible termination member comprises a disc portion comprising a peripheral edge making solderless physical and electrical contact with the corresponding front pad of the circuit board.

5. The connector assembly of claim 1, wherein the unitary front housing is removably assembled to the open front end of the of the unitary rear housing by the unitary front housing moving toward the unitary rear housing along a mating direction of the connector assembly until the front end of the circuit board deflects the flexible termination members of the contacts away from the circuit board and a latch of one of the front and rear housings engages an engagement member of the other one of the front and rear housings.

6. A connector assembly configured to mate with different mating connectors by virtue of having different removably assembled interchangeable front housing portions, the connector assembly comprising:
a circuit board comprising a plurality of conductive front pads disposed at a front end of the circuit board and a plurality of conductive rear pads disposed at an opposite cable end of the circuit board;
a cable terminated at the plurality of the rear pads; and
a rear housing portion housing the circuit board and portions of the cable, the front pads of the circuit board disposed proximate an open front end of the rear housing portion, such that a front housing portion of the connector assembly is removably assembled to the open front end of the of the rear housing portion when the front housing portion moves toward the rear housing portion along a mating direction of the connector assembly until the front end of the circuit board deflects flexible contacts of the front housing portion away from the circuit board and a latch of one of the front and rear housing portions engages an engagement member of the other one of the front and rear housing portions.

7. The connector assembly of claim 6, wherein the rear housing portion is overmolded around the circuit board and tightly encloses the rear pads.

8. The connector assembly of claim 6, wherein the rear housing portion is a unitary construction.

9. A connector configured to mate with different mating connectors by virtue of having different removably assembled interchangeable front housing portions, the connector comprising:
a rear housing portion comprising a plurality of rear contacts, such that when the connector is to mate with a particular mating connector, a particular front housing portion of the connector corresponding to the particular mating connector is selected from a plurality of available different front housing portions, and removably assembled to the rear housing portion, so that a plurality of front contacts of the particular front housing portion make solderless physical and electrical contact with the plurality of rear contacts of the rear housing portion, the plurality of front contacts of the front housing portion adapted to mate with corresponding contacts of the particular mating connector.

10. The connector of claim 9, wherein the plurality of rear contacts comprises a plurality of upper rear contacts and a plurality of lower rear contacts, and wherein the plurality of front contacts comprises a plurality of upper front contacts and a plurality of lower front contacts, such that when the particular front housing portion is removably assembled to the rear housing portion, the upper front contacts deflect upwardly and make solderless physical and electrical contact with the upper rear contacts, and the lower front contacts deflect and make solderless physical and electrical contact with the lower rear contacts, the deflection of the upper and lower front contacts generating deflection force ensuring electrical connection between the front and rear contacts.
